(19) United States
(12) Patent Application Publication
(10) Pub. No.: US 2006/0272880 A1
(43) Pub. Date: Dec. 7, 2006

(54) SHEAR STRAIN CARRYING JOINT BETWEEN TWO ABUTTING ELEMENTS IN A MOTOR VEHICLE

(75) Inventors: Roland Svensson, Varobacka (SE); Jan-Olf Bodin, Alingsås (SE)

Correspondence Address: NOVAK DRUCE & QUIGG, LLP, 1300 EYE STREET NW, 400 EAST TOWER, WASHINGTON, DC, 20005, US

(73) Assignee: VOLVO LASTVAGNAR AB, Goteborg (SE)

(21) Appl. No.: 11/279,878

(22) Filed: Apr. 14, 2006

Related U.S. Application Data
(63) Continuation of application No. PCT/SE04/01454, filed on Oct. 12, 2004.

(30) Foreign Application Priority Data
Oct. 15, 2003 (SE) 0302741-4

(51) Int. Cl. B60K 17/00

(52) U.S. Cl. 180/349

(57) ABSTRACT

Shear strain-carrying joint (1) between two parts (2, 3) abutting one another in a motor vehicle. The joint includes two pins (4, 5) arranged in pairs, securely fixed in the one part (2) projecting upwards from an abutting surface (9) and situated at a selected interval (a) form one another. Openings (7, 8) are furthermore arranged in an abutting surface (6) on the second part (3) and situated at a corresponding interval from one another. The pins are dimensioned, shaped and positioned such that they each fit in one of the openings. The pins (4, 5) in a base section have two convexly curved mating surfaces (20, 21) that give each pin a selected cross-sectional dimension (d) between the mating surfaces. In the assembled state, the mating surfaces of the parts coincide with sections of the peripheral surface (29) of the openings. Between the curved mating surfaces (20, 21) of the pins sections (15, 16) are arranged, in which each pin has a smaller cross-sectional dimension (x) than the cross-sectional dimension between the mating surfaces.

### CROSS-REFERENCE TO RELATED APPLICATIONS

The present application is a continuation patent application of International Application No. PCT/SE2004/001454 filed 12 Oct. 2004 which is published in English pursuant to Article 21(2) of the Patent Cooperation Treaty and which claims priority to Swedish Application No. 0302741-4 filed 15 Oct. 2003. Said applications are expressly incorporated herein by reference in their entireties.

### TECHNICAL FIELD AND BACKGROUND OF THE INVENTION

The present invention relates to a shear strain-carrying joint between abutting parts in a motor vehicle. The joint comprises at least two pins (4, 5) securely fixed in one of the parts (3) projecting upwards from an abutting surface (9) and situated at a selected interval (a) from one another. There is a corresponding number of openings (7, 8) in an abutting surface (6) on second part and which are situated at corresponding intervals from one another. The pins are dimensioned, shaped and positioned so that they each fit in one of the openings.

Arranging pins that project from an abutting surface in the first part and are inserted into corresponding openings in a surface of the second part in order to carry shear strains between two mechanical parts is known in the art. These existing pins also serve as locating pins in order to ensure a correct positioning of the parts in relation to one another. The desire to avoid movements in the joint which can cause damaging peak strains, and also to avoid loose fits, assembly problems have arisen in assembling the joint resulting in a so-called drawer effect, which has meant that great forces are required in order to press the parts together during assembly to achieve an acceptable connection.

### SUMMARY OF THE INVENTION

A primary object of the invention is to produce a joint in which relatively large tolerance variations can be accommodated while at the same time obtaining a firm joint without harmful movements of the parts relative to one another.

### BRIEF DESCRIPTION OF THE DRAWINGS

The invention will be described in more detail below using exemplary embodiments and with reference to the accompanying drawings in which:

FIG. 1 is a partially broken schematic plan view of a joint configured according to a first example of the invention and which includes two locating pins;

FIG. 2 is a partially broken and partially sectioned exploded view of the joint of FIG. 1;

FIG. 3 is a view corresponding to FIG. 2, but with the joint in an assembled configuration;

FIG. 4 is a section taken along the line 4-4 in FIG. 3;

FIG. 5 is a view, corresponding to FIG. 1, of a shear joint configured according to a second exemplary embodiment having three locating pins;

FIGS. 6, 7 and 8 are different views of one of the locating pins forming part of the joint of FIG. 5;

FIG. 9 is an alternative embodiment of a locating pin of the invention; and

FIGS. 10 and 111 are a top view and a side view, respectively, of the joint forming part of a wheel axle for a motor vehicle.

### DETAILED DESCRIPTION

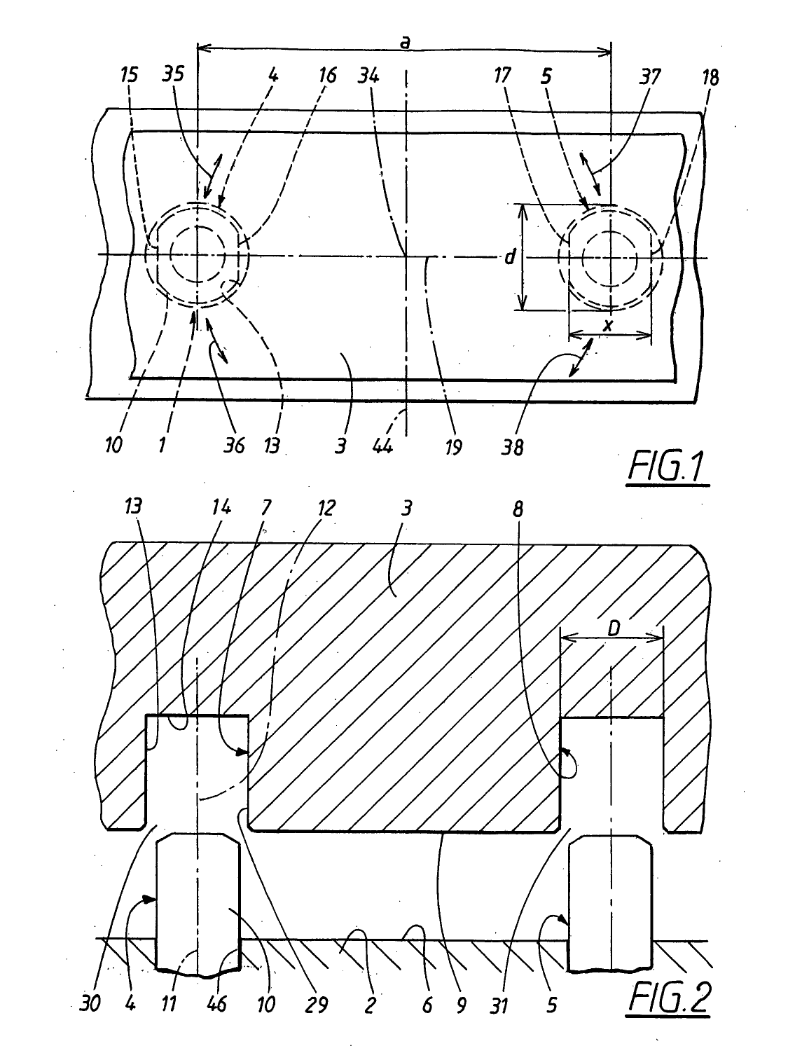

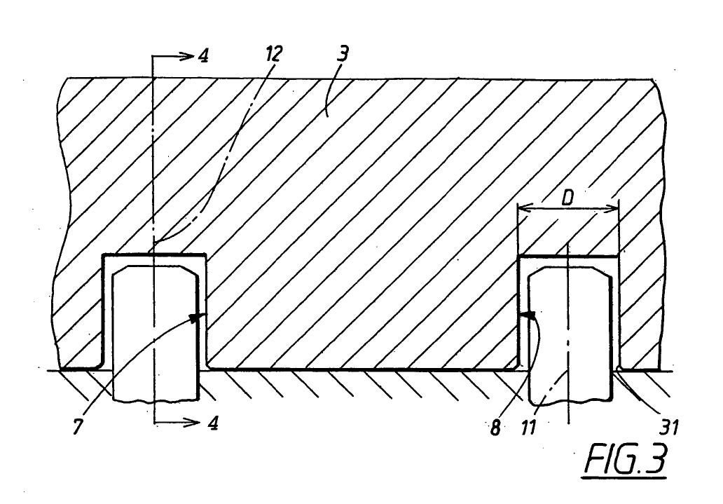

The joint according to the invention is a shear strain-carrying joint 1 between two parts 2, 3 that are to be rigidly secured; that is, without movements relative to one another. The one part 2 can be a part of a wheel axle, for example, such as a rear axle for a motor vehicle. The second part 3, for example, can be fixed to a spring assembly which could exemplarily be part of the wheel suspension for a chassis of a motor vehicle. The construction of the joint will first be described in an example with reference to FIGS. 1-4.

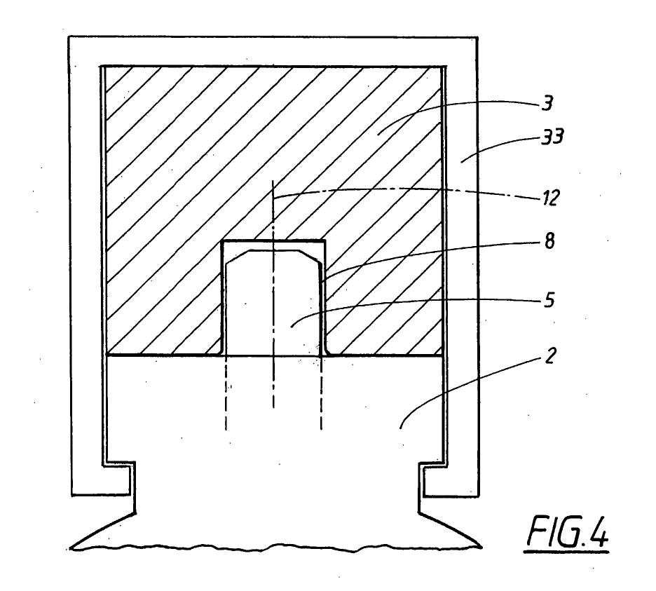

Forming the main parts of the joint are pins, which for the sake of simplicity will henceforth be referred to as locating pins 4, 5, of which there are two in the first example that project upwards from an abutting surface 6, which may be a plane surface in the one part. The locating pins are intended for insertion in the second part of the joint, more specifically in a number corresponding to the number of openings 7, 8 in the second part. In the first example, the openings 7, 8 consist of two openings in an abutting surface 9 which is shown as a planar surface, the parts in the assembled state being intended to abut one another (see FIGS. 3 and 4).

The main function of the locating pins 4, 5 is to carry shear strains through interaction with the openings. In the example shown, the locating pins 4, 5 are exemplarily of an essentially cylindrical shape; that is, with a cylindrical side surface 10 over a part of their circumference. The locating pins extend with their axis of symmetry 11 at a right angle to the abutting surface.

The openings 7, 8 are correspondingly cylindrical and extend with an axis of symmetry 12 at right angles to the abutting surface of the second part 3. In the example shown, the openings are provided with a concave, simply curved surface. In the example shown, a cylindrical lateral surface 13 is shown that extends in the direction of the axis of symmetry 12 which is equal to, or somewhat greater than the cylindrical lateral surface 10 of the locating pins in the corresponding direction; that is, in the direction of the axis of symmetry 11. For the rest, the bottom face 14 of the openings may be formed with any shape so that contact does not occur in the assembled joint. For example, the bottom surface 14 may be entirely plane or may be of a shape similar to the top surface of the locating pins 4, 5.

The two locating pins are situated at a selected interval from one another and the openings there for are situated at an equal interval with a selected maximum tolerance deviation. The locating pins further have a selected diameter, d, while the openings have a selected diameter, D, which deviates somewhat by a predetermined amount from the diameter of the locating pins within the scope of the selected tolerance deviations of both the locating pins and the openings.

In order to permit relatively large tolerance deviations with respect of the interval, while at the same time minimizing the tolerances for the diameter, d, of the locating pins and the diameter, D, of the openings, the locating pins are provided with sections 15-18 of the lateral surface where the pin has a reduced cross-sectional dimension, x. More specifically, the sections give a reduced, suitably equal distance to the axis of symmetry 11, which in the example is half the value of the cross-sectional dimension, x. In the example shown, this is achieved in that the sections 15-18 consist of beveled sections, or bevels, which need not necessarily mean that these are formed by machining, such as milling. It is possible to form the beveled portions from the outset during production of the locating pins. For the sake of simplicity, these will hereafter simply be referred to as bevels. As shown in the example, these are plane surfaces which, in the example, extend at a uniform, constant distance from the axis of symmetry 12 over the entire height of the locating pins, or a part of the height that is intended for insertion into the openings 7, 8 in the part 3.

As may be best appreciated in FIG. 1, the bevels 15-18 are aligned so that they are symmetrical in relation to a common axis of symmetry 19; that is, the two bevels 15, 16 and 17, 18 of the locating pins are situated diametrically opposite to one another and averted from one another. They are further oriented so that two of the bevels 15, 18 face outwards, away from one another, while the other two bevels 16, 17 face one another. In the example shown, all bevels extend in planes parallel to one another. In the example, it is furthermore assumed that the two locating pins 4, 5 are identical in shape and dimensions, but these features are not essential.

FIG. 5 shows a second example of a shear joint configured according to the present invention, and in which there are three locating pins. The two outer locating pins 4, 5 in the example are identical to the locating pins of FIG. 1 and each is inserted in the same way into an opening that is beveled in the same way as the previous example. A third locating pin 48 is arranged and inserted into a corresponding opening in the second part 3. In the example shown, the third locating pin lies on the same axis of symmetry 19 as the other two locating pins and at the same distance from each of the two outer locating pins; that is, centrally in relation to the transverse axis of symmetry 44 of the joint. This configuration is in no way essential, however; it being possible for the third locating pin to lie outside the axis of symmetry 19, although it is still advantageously equidistant from the two outer locating pins; that is to say, it is located along the transverse axis of symmetry 44. The three locating pins in this manner form the angles of an isosceles triangle. In the example shown, the bevels 49, 50 of the third locating pin 48 are furthermore positioned at right angles to the bevels 15-18 of the other two locating pins. The central locating pin 48, however, is angularly offset by 90° in relation to the two outer locating pins. The embodiment according to FIG. 5 affords the same advantages as in the first embodiment, while also carrying greater shear forces since the total shear strain-carrying surface is increased for the same dimensions.

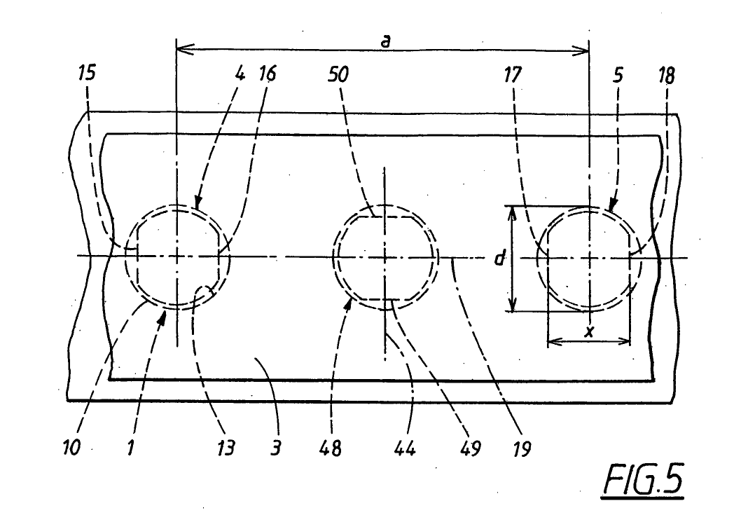

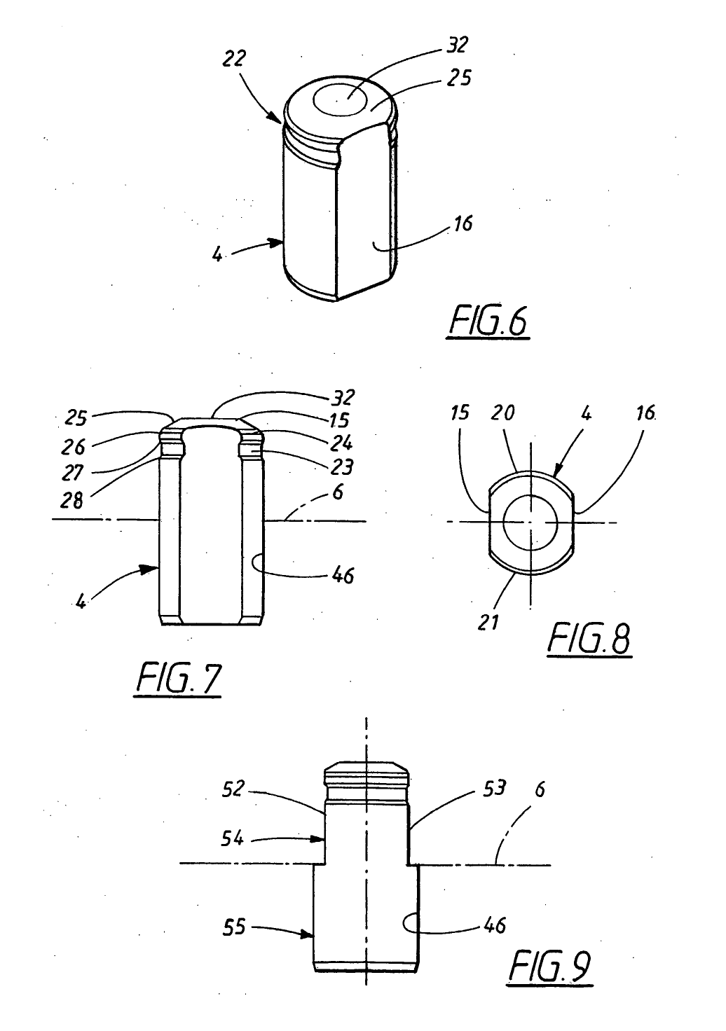

FIGS. 6, 7 and 8 show more clearly an example of the detailed design of a locating pin 4. It can be seen from these figures that the two bevels 15, 16 divide the lateral surface into paired opposing sections. Not only the bevels 15, 16, but also the two are convexly curved. In the example shown, cylindrically curved sections 20, 21 of the lateral surface form the so-called mating surfaces in the joint and extend over the greater part of the height of the locating pin. In the example shown, the locating pin 4 has a entering arrangement 22 directly adjoining the top surface of the pin 4 which in a primary aspect has a neck section 23 that is suitably a cylindrical section having a somewhat smaller diameter than the remaining diameter, d, of the locating pin. A main section 24 in the example has the same diameter, d, as the mating surfaces 20-21 of the locating pin, although it may be somewhat smaller.

Also to be encountered are conically beveled or rounded surfaces (shoulders) 25, 26, 27, 28, which form guide and entering surfaces in order to prevent catching against a circular aperture edge 29 of the openings around the aperture 30 of the openings. The aperture edges can also advantageously be provided with conical bevels 31. Instead of conical bevels, the surfaces may also be rounded. Thus, in the example, the top surface is divided up into the conical bevel 25 and a plane end surface 32. The top surface may alternatively be entirely conical or convexly domed. However, the top surface should not carry transverse loads in the longitudinal direction of the axis of symmetry 12 originating from the part 3, but the forces acting on the first part 2 should instead be carried by the two abutting surfaces 6, 9.

In the example, the effective length of the locating pin is shorter than its overall length, since it is intended for anchoring in a bore 46 in the one part 2 and is suitably secured by press-fitting. For example, the pin may project upwards by approximately half its total length (see the horizontal dot-and-dash line 6 in FIG. 7).

As is indicated in FIG. 4, the joint 1 is supplemented by, for example, one or two fastening members 33 in the form of clamps that enclose the one part 3 and are secured to the second part. This serves to absorb any forces that strive to separate the two parts 2, 3 from one another in a transverse direction to the extent of the abutting surfaces 6, 9; that is, in the direction of the axis of symmetry 12.

FIG. 9 shows an alternative embodiment of a locating pin 4, which has bevels 52, 53 that extend only over the part 54 of the pin projecting upwards, while the part 55 in the bore 46 may be entirely cylindrical.

It will be appreciated from FIGS. 1-5 that assembly (bringing the two parts 2, 3 together) can be done without having to overcome large forces since the bevels of the locating pins, by virtue of their orientation, will tolerate deviations in the direction of the connecting line 19; that is, deviations from a specific spacing interval, a. The larger the bevels, the greater the tolerance obtained, while the absorption of shear strain is reduced by a certain radius of curvature. The shear strain is carried entirely by the two cylindrical lateral surfaces 20, 21 of the locating pins bearing against the lateral surface 13 of the openings 7, 8. In many assemblies the shear strain occurs due to reciprocal lateral forces acting transversely to the connecting line 19 in the plane of projection according to FIG. 1.

These lateral forces often occur due to torque that occurs, for example on the second part 3 around the center of rotation 34 of the joint, usually the mid-point between the locating pins and the openings (see force arrows 35, 36, 37, 38). It will be appreciated that the absence of cylindrical sections in the locating pins has less significance in terms of the ability to carry shear strain than the lateral surface sections 20, 21, which face the direction of the force. The absence of the lateral surface section for a certain diameter can be compensated for by the choice of locating pins and openings having a larger diameter so that the effective shear strain-carrying surface is retained. Examples of the design dimensions of bevels include reducing the transverse dimension by 5-40%, for example 10%; that is, the dimension, x, is 90% of the diameter d (see FIGS. 1 and 5).

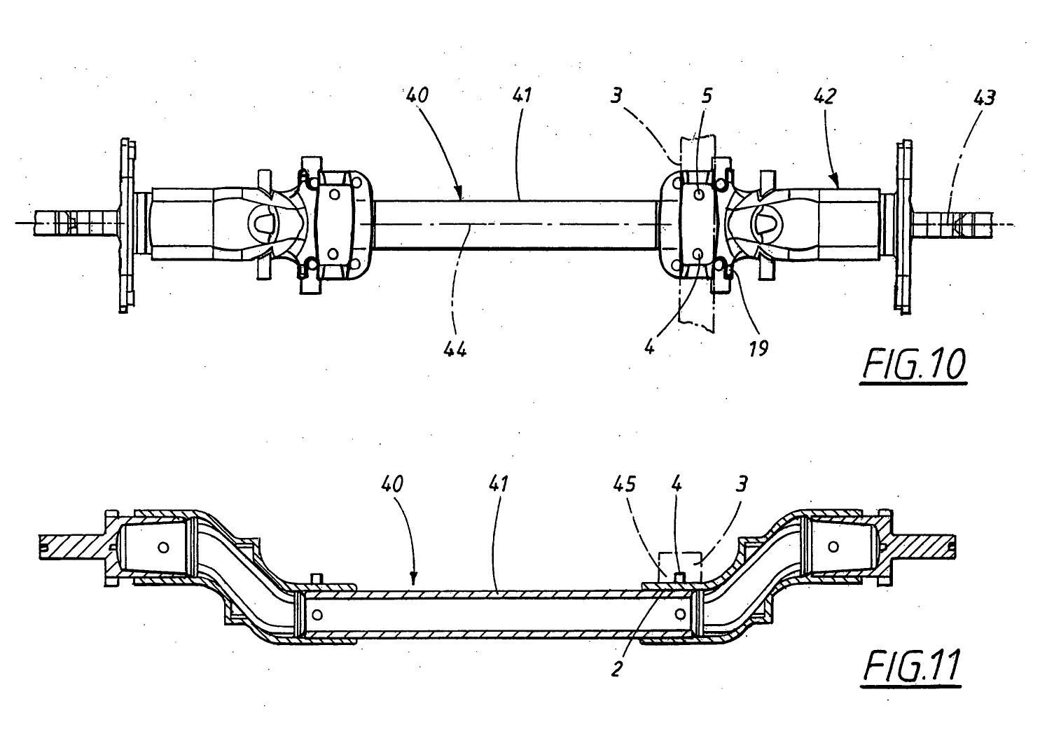

FIGS. 10 and 11 show an applied example of the joint 1 incorporated on a motor vehicle, more specifically the vehicle's rear axle 40, which in the example is of the rigid axle type. The rear axle is divided up into a cylindrical, central tube 41, which at its two ends is connected to axle sections 42, which are purposely designed to carry a wheel (not shown) at the ends 43 of the wheel axle. In the example shown, the axle sections 43 are bent in an S-shape in order to satisfy requirements relating to clearance, center of gravity and the like. The axle sections 42 are usually made of a cast or forged material, while the center tube 41 may be made from a continuously manufactured sheet steel tube. The axle sections 42 are designed to be provided with one part of the joint; that is, the locating pins 4, 5, while a spring holder, which is indicated by the dot-and-dash line 45, is provided with the second part 3 of the joint; that is to say, the openings 7, 8, or vice versa. In the example, the joint is so aligned that the locating pins and the openings are arranged in the longitudinal direction of the vehicle; that is, the connecting line 19 extends in the longitudinal direction of the vehicle, which is transversely to the axis of symmetry 44 of the vehicle. The two parts are held together by means of clamps of the type shown in schematic form in FIG. 4, while it will be appreciated that the joint between the two parts (the axle section 42 and the spring holder 45) are exposed to large shear forces, which for the most part are dynamic forces and may have high peak values, the greatest forces being directed in a way explained with reference to FIG. 1; that is, torsional forces in the horizontal plane and also purely linear lateral forces in the horizontal plane in the longitudinal direction of the wheel axle.

It should be appreciated that the invention is not limited to the exemplary embodiments described above and shown in the drawings, but may be modified without departing from the scope of the following claims. The joint is therefore designed as at least two locating pins and corresponding openings so that there may be more than two or three, for example four, five or six locating pins in the one part and a corresponding number of openings in the other part. In principle, the locating pins and corresponding openings may feasibly have some shape other than a basic cylindrical shape, for example a conical or combined cylindrical and conical shape. The bevels may also feasibly be convexly curved surfaces rather than plane surfaces. However, the bends must have a larger radius of curvature that the mating surfaces; that is, entailing a reduction in the cross-sectional dimension. The abutting surfaces 6, 9 may feasibly be surfaces other than planar surfaces, but must be complementary in such a way that they result in abutment with one another over at least a part of the surfaces facing one another. Not only can the openings and locating pins change places, so that the first lower part is provided with openings, this facility may also be combined so that one locating pin is fixed in the one part and the next locating pin in the second part. The shear strain-carrying joint may furthermore be intended for carrying shear strains between two other parts in a motor vehicle where dynamic forces occur, for example in the engine, such as an internal combustion engine, or in the transmission.

What is claimed is:

1. A shear strain-carrying joint (1) between two parts (2, 3) abutting one another in a motor vehicle, the joint comprising:
at least two pins (4, 5) securely fixed in a first (3) of the two parts (2, 3) and projecting away from an abutting surface (9) of the first part (3), said at least two pins (4, 5) being positioned at a selected interval (a) from one another;
a number of openings (7, 8) corresponding in number to that of the at least two pins (4, 5) being located in an abutting surface (6) on a second (2) of the two parts (2, 3) and also situated at the selected interval (a) from one another;
each of said pins (4, 5) being dimensioned, shaped and positioned to fit in one of the openings and projecting outwards from the abutting surface (9) of the first part (3), each of said pins (4, 5) further having two convexly curved mating surfaces (20,21) which give each pin a selected cross-sectional dimension (d) between the mating surfaces; and
said pins (4,5) are configured so that when the parts (2, 3) are in an assembled configuration, the two convexly curved mating surfaces (20,21) of each pin (4, 5) conformance fit with sections of an interior peripheral surface (29) of a respective opening (7, 8) within which said pin (4, 5) is located and between the curved mating surfaces (20,21) extend two flat sections (15, 16) that have a smaller cross-sectional dimension (x) than the diameter (d) between the two convexly curved mating surfaces (20,21) of the pin (4, 5).

2. The shear strain-carrying joint as recited in claim 1, wherein the two flat sections (15, 16) between the two convexly curved mating surfaces (20, 21) consist of planar bevels.

3. The shear strain-carrying joint as recited in claim 2, wherein the cross-sectional dimension (x) between the two planar bevels constitutes a reduction of between 5-40% of the cross-sectional dimension (d) at the two convexly curved mating surfaces (20, 21).

4. The shear strain-carrying joint as recited in claim 3, wherein the reduction is approximately 10%.

5. The shear strain-carrying joint as recited in claim 3, wherein the reduction is approximately 20%.

6. The shear strain-carrying joint as recited in claim 1, wherein each pin (4, 5) has an entering arrangement (22) above the base section.

7. The shear strain-carrying joint as recited in claim 6, wherein the entering arrangement (22) has narrowing beveled surfaces (23-27).

8. The shear strain-carrying joint as recited in claim 2, wherein the planar bevels extend at least over the projecting height of the pins (4, 5).

9. The shear strain-carrying joint as recited in claim 1, wherein one of the two parts (2, 3) constitutes a portion of a wheel axle (40) and the other of the two parts (2, 3) constitutes a part of a spring holder.

10. The shear strain-carrying joint as recited in claim 1, wherein the parts (2, 3) are held against one another by a fastening device (33).
